(19) United States
(12) Patent Application Publication
(10) Pub. No.: US 2007/0120382 A1
(43) Pub. Date: May 31, 2007

(54) Coupling drive from an actuator to a mechanism

(76) Inventor: John P. Chevalier, London (GB)

Correspondence Address: DICKSTEIN SHAPIRO LLP, 1825 EYE STREET NW, Washington, DC, 20006-5403, US

(21) Appl. No.: 11/585,198

(22) Filed: Oct. 24, 2006

(30) Foreign Application Priority Data
Nov. 11, 2005 (GB) 0523032.1

(51) Int. Cl. E05B 3/00

(52) U.S. Cl. 292/336.3

(57) ABSTRACT

Apparatus for coupling operational drive mechanically by way of a cable from an actuator to a mechanism such as a door latch, comprising: a frame for mounting in a fixed position relative to the door latch and the actuator; an inertia lever pivotally mounted on a bracket constrained to slide along a predetermined path within the frame, the inertia lever having a centre of mass distant from its pivotal mounting on the bracket; a catch constrained to slide along a predetermined path within the frame, following the path of the inertia lever; means for connecting the bracket to the actuator; and means for connecting the catch to the said mechanism such as a door latch; the apparatus being configured such that when the inertia lever is at a position at which it locks against the catch to couple drive from the actuator to the cable, its centre of mass is shifted transversely from a line through its pivotal mounting on the bracket parallel at that point to the path of the inertia lever; such that when no driving force is applied from the actuator there is an axial gap between mutually-engaging surfaces of the catch and the inertia lever, but when the actuator applies normal driving force, the inertia lever slides to close that gap and then to lock against the catch; and such that axial acceleration of the inertia lever above a predetermined threshold, corresponding to an unsafe fault condition, causes the off-axis inertia lever to swing to move its centre of mass closer to axial alignment with its pivotal mounting point, sufficiently to bypass the catch by the time the gap has closed, whereby to decouple the operational drive.

This apparatus relates to apparatus for coupling operational drive mechanically by way of a cable from an actuator, such as a handle or an electrical actuator mechanism to an actuable mechanism such as a door latch. It is particularly useful in automotive applications.

In modern vehicles such as passenger cars each of the side doors and the tailgate has an electrically-controlled latch, and there are usually systems for selective manual or electrical latch operation, to open the doors or the tailgate. Manual operation of the door latch is usually through the use of interior and exterior door handles connected by cables to the latch actuator. Such an arrangement is described for example in my publication WO 98/27301.

Safety standards such as UN Regulations 94 and 95 and EC Regulation No. 11, Amendment No. 2 require that car doors do not open accidentally upon impact of the vehicle, or for example if the vehicle rolls or spins following a side impact. At least one of the doors should however be capable of being opened manually after such an accident. When a vehicle crashes, spins or rolls, it has been found that accelerations of up to about 30 G may be experienced, this value being incorporated in the EC safety standard, and of course these accelerations may occur along any axis of the vehicle. Such accelerations can be sufficient to operate a door handle causing inadvertent opening of the door.

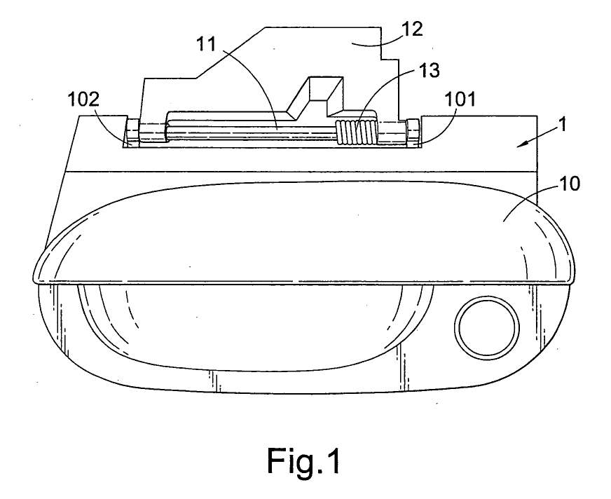

To prevent exterior door handles turning when a vehicle undergoes severe acceleration, the conventional approach has been to provide counterweights adjacent the door handle, as shown in FIG. 1 of the accompanying drawings. (In this specification, references to acceleration are intended to include deceleration, i.e. a sudden shock along any direction). Typically, a counter-weight is rotationally coupled to the door handle using a spring arrangement, so that inertial movement of the door handle is countered by corresponding inertial movement of the counter-weight, in the event of abnormal accelerations. Due to the normal orientation of door handles on a vehicle, this would normally be relevant when the vehicle suffers a side impact or rolling about its main axis.

The problem with providing counterweights is that this adds to the weight of the vehicle and to the complexity and cost of manufacture of the door handle arrangement.

Most door handles have a return spring, and we have found that the maximum necessary force for lifting a typical handle is 10 N. In order to meet the safety standards described above, several vehicle manufacturers use harder springs, requiring say 35 N to open the handle—leading to unnecessary effort from the user. This has also led to the use of power-release mechanisms.

Alternative solutions have included providing the latch with internal inertia-responsive levers or other components, so that the latch is locked against opening movements, when the latch experiences undue acceleration in a specific predetermined axis. These arrangements introduce complexity and cost into the latches, and moreover, by their very nature, they cannot be incorporated retrospectively into latches of existing design.

Accordingly the purpose of the present invention is to overcome these disadvantages with prior arrangements, whilst at the same time reducing the cost of the system, preferably in a way which is compatible with existing systems.

The present invention provides apparatus for coupling operational drive mechanically by way of a cable from an actuator to a mechanism such as a door latch, comprising: a frame for mounting in a fixed position relative to the door latch and the actuator; an inertia lever pivotally mounted on a bracket constrained to slide along a predetermined path within the frame, the inertia lever having a centre of mass distant from its pivotal mounting on the bracket; a catch constrained to slide along a predetermined path within the frame, following the path of the inertia lever; means for connecting the bracket to the actuator; and means for connecting the catch to the said mechanism such as a door latch; the apparatus being configured such that when the inertia lever is at a position at which it locks against the catch to couple drive from the actuator to the cable, its centre of mass is shifted transversely from a line through its pivotal mounting on the bracket parallel at that point to the path of the inertia lever; such that when no driving force is applied from the actuator there is an axial gap between mutually-engaging surfaces of the catch and the inertia lever, but when the actuator applies normal driving force, the inertia lever slides to close that gap and then to lock against the catch; and such that axial acceleration of the inertia lever above a predetermined threshold, corresponding to an unsafe fault condition, causes the off-axis inertia lever to swing to move its centre of mass closer to axial alignment with its pivotal mounting point, sufficiently to bypass the catch by the time the gap has closed, whereby to decouple the operational drive.

The actuator may be a conventional door handle, or it may be an electrical actuator.

The apparatus may be provided entirely separately from conventional latches and conventional door handles, as a self-contained unit which may be connected in line to the drive cable. Alternatively, the apparatus may be formed adjacent, or integrated with, an electrical actuator. Either way, the apparatus embodying the invention is capable of ensuring that the door is not opened by erroneous operation of the latch from the actuator, in the event of excessive accelerations in the actuator, in any axis and in any direction.

It will be appreciated that the invention differs from inertia-responsive latch arrangements of prior publications, since the apparatus of the invention is responsive to the degree of acceleration applied from the door handle or other actuator. This allows the coupling apparatus and also the handle to be placed in any desirable location and at any desirable orientation, regardless of the axes of impacts or accelerations. This confers extra reliability on the invention, and greater freedom in vehicle design.

The invention avoids the need for hard return springs on the door handle, leading to increased user comfort.

The invention is also advantageous because it can be made with relatively few components, almost all of which can be made of plastics materials. This enables the invention to be made relatively inexpensively and of light weight. Vehicles fitted with the invention no longer require door handles to be counter-balanced, and this can significantly reduce vehicle weight.

The invention also provides a method of decoupling drive from an actuator to a mechanism such as a door latch in the event of abnormal acceleration such as upon impact, using mechanical coupling apparatus therebetween, in which the coupling apparatus couples the drive when operated normally but decouples the drive whenever the acceleration of the drive applied by the actuator exceeds a pre-determined threshold.

In order that the invention may be better understood, preferred embodiments of the invention will now be described by way of example, with reference to the accompanying drawings, in which:

FIG. 1 shows a conventional door handle assembly including a counter-weight;

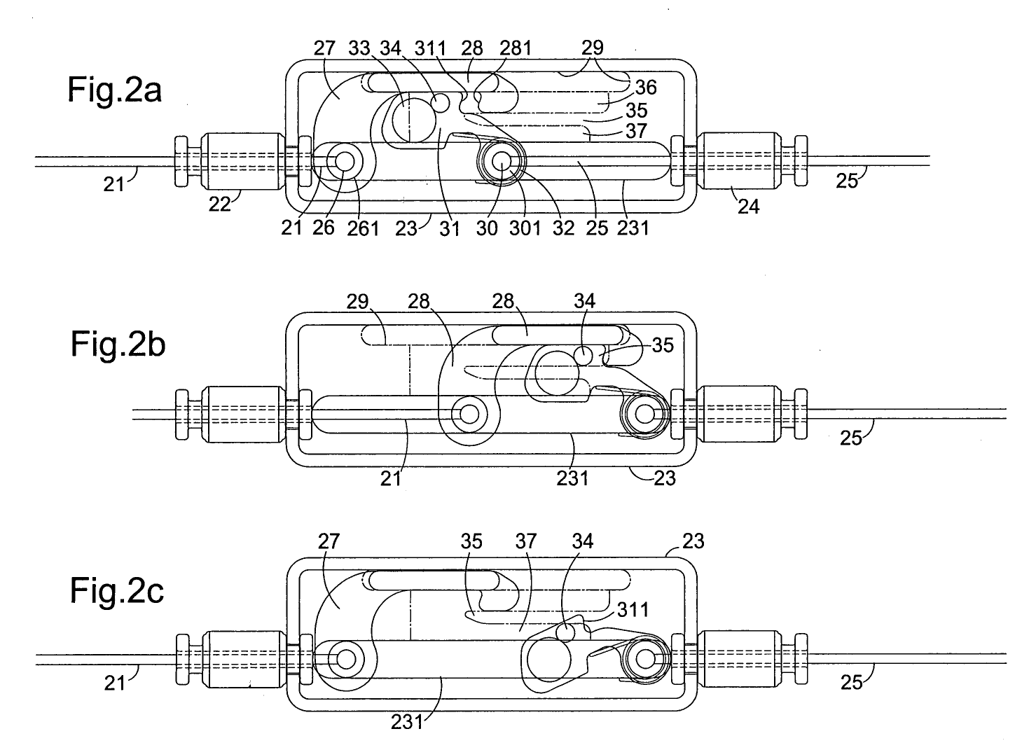

FIGS. 2a to 2c show coupling apparatus according to a first embodiment of the invention, with FIG. 2a showing the apparatus at rest, FIG. 2b showing it coupling drive under normal operation, and FIG. 2c showing it decoupled under excessive acceleration;

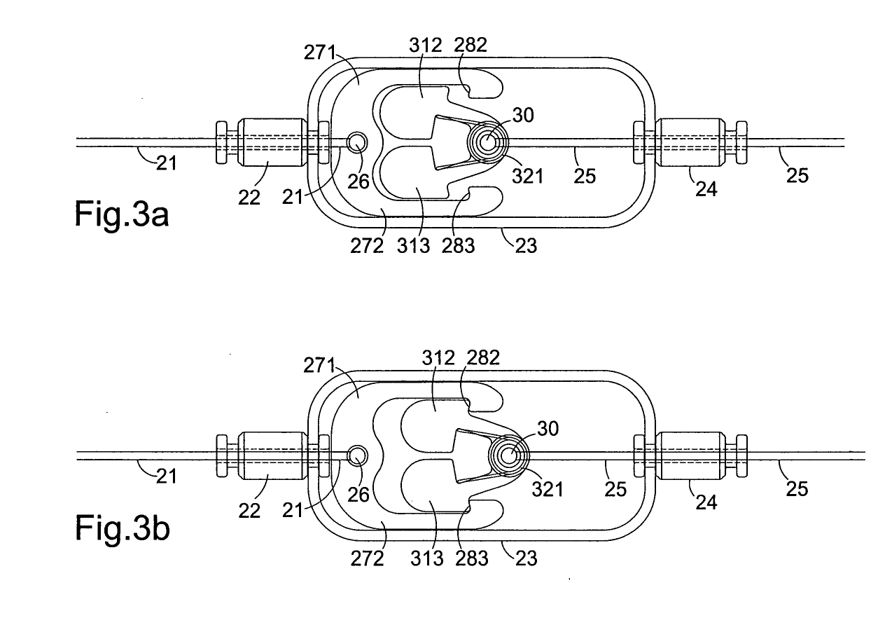

FIGS. 3a to 3d show apparatus according to a second embodiment of the invention, with inertial components provided in tandem, in which FIG. 3a shows the apparatus at rest, FIG. 3b shows a first stage of normal operation, FIG. 3c shows a second stage of normal operation, and FIG. 3d shows decoupling under abnormal operation;

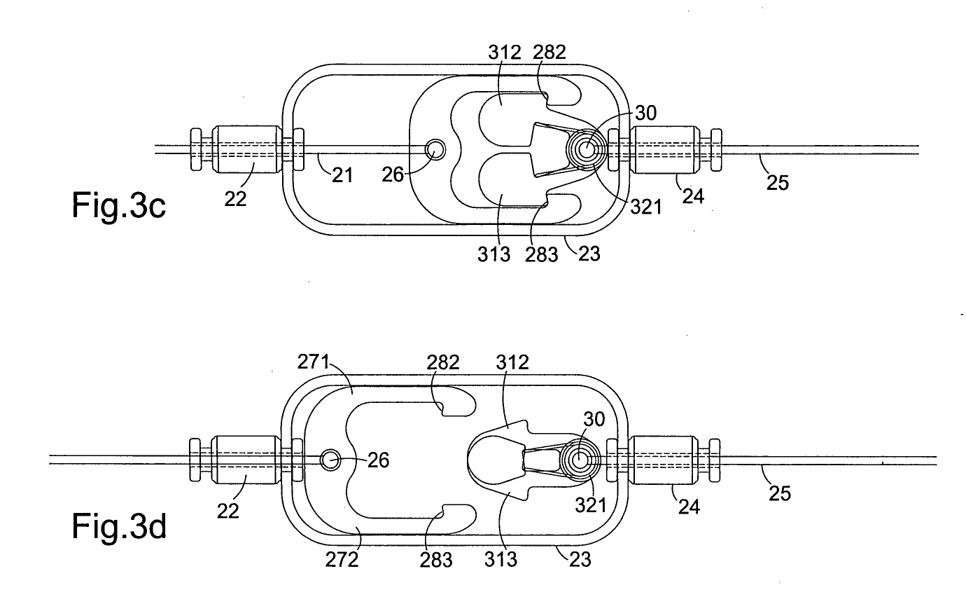

FIGS. 4a and 4b show apparatus according to a third embodiment of the invention, in which a ratchet is provided to lock movement of the door handle, in which FIG. 4a shows the apparatus at rest, and FIG. 4b shows the apparatus under abnormal operation, with drive decoupled and also with the door handle cable locked against the ratchet;

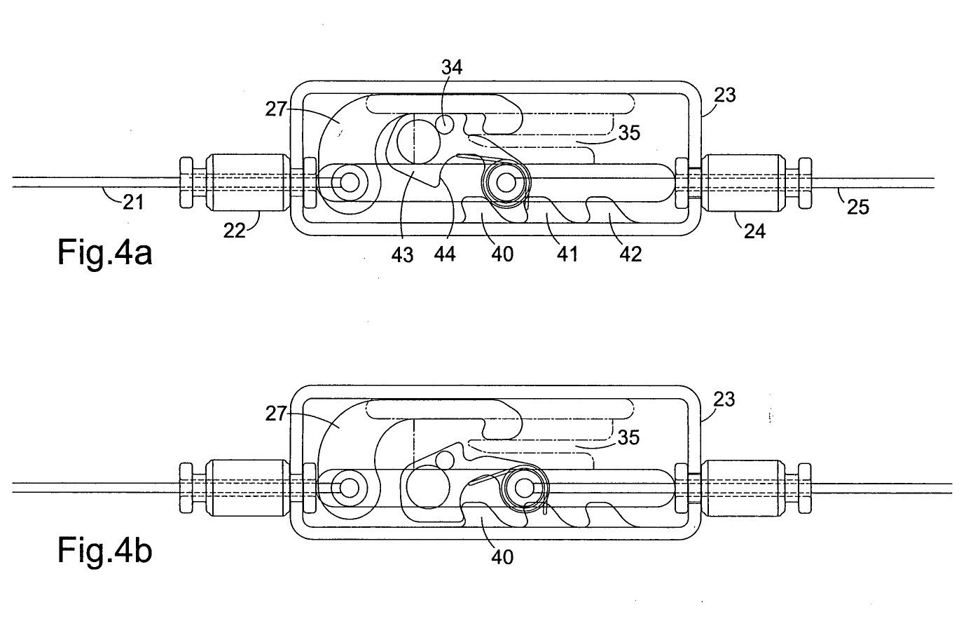

FIGS. 5a and 5b show apparatus according to a fourth embodiment of the invention, in which ratchets are provided on both sides, in which FIGS. 5a shows the apparatus at rest, and FIGS. 5b shows the effect of a transverse acceleration applied to the apparatus itself;

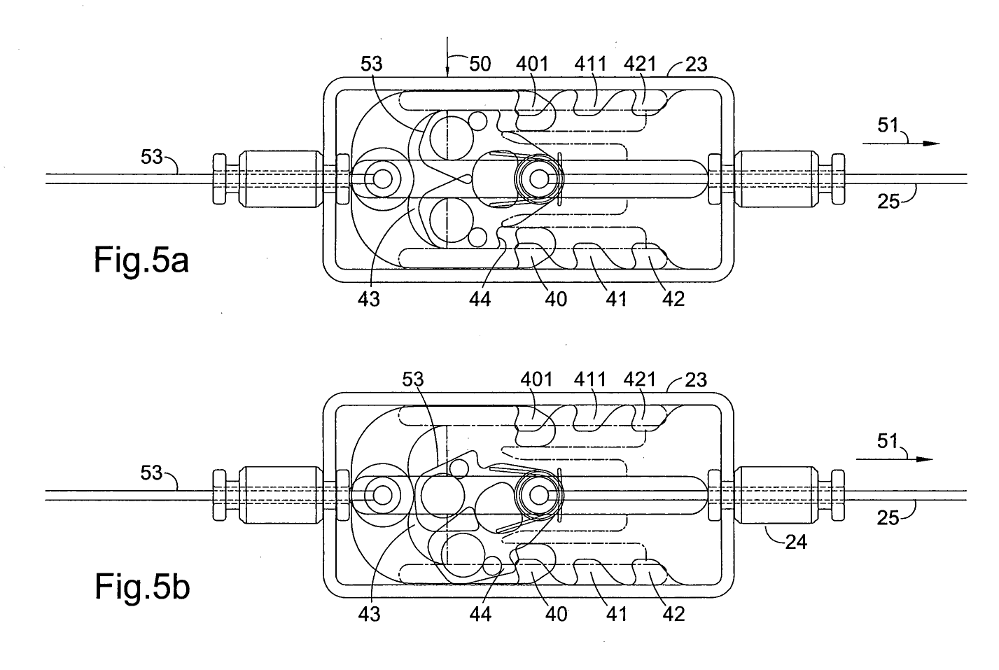

FIG. 6 is a perspective view of apparatus according to the first embodiment of the invention, but slightly modified with regard to the connection of the door handle cable, with the lid of the apparatus housing removed to show internal components;

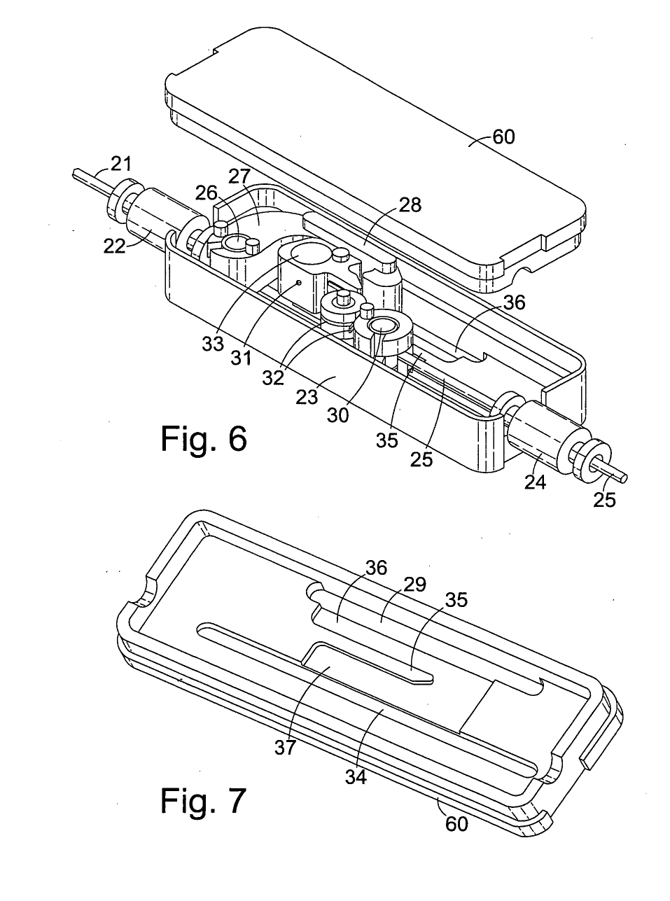

FIG. 7 shows the underside of the lid of the apparatus of FIG. 6;

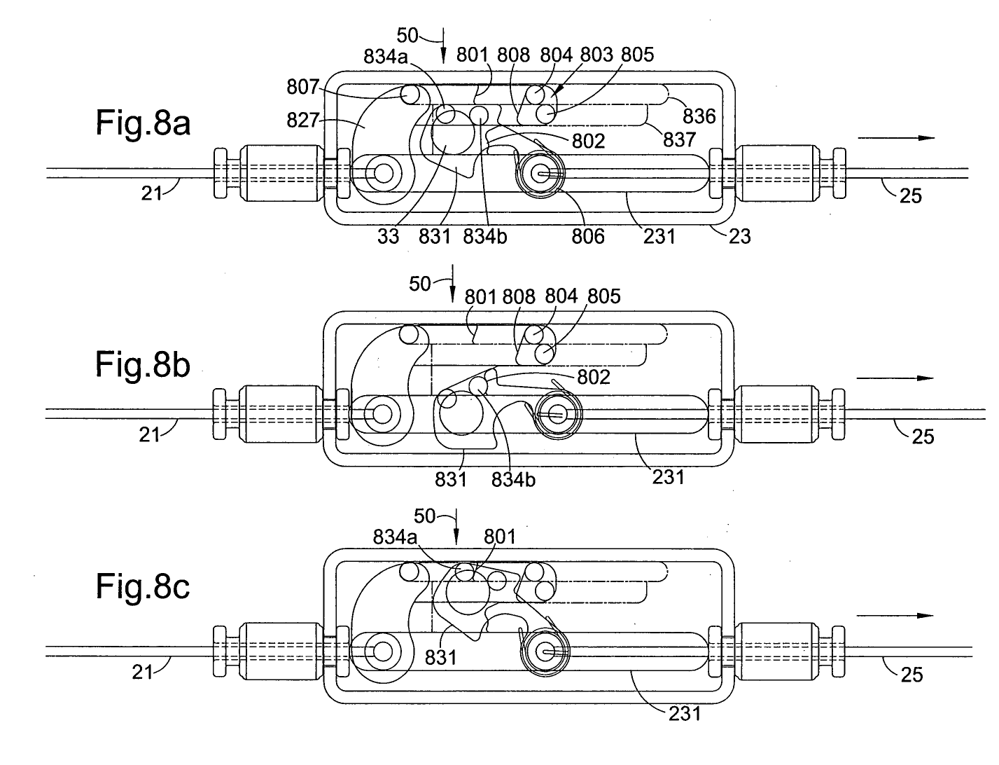

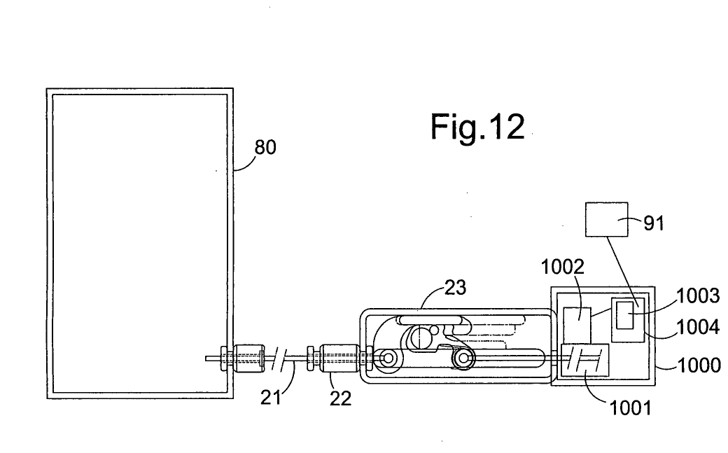

FIGS. 8a and 8c show apparatus according to a fifth embodiment of the invention, in which FIG. 12a illustrates normal safe door handle operation, FIG. 12b illustrates door handle blocking due to excessive acceleration of the door handle cable, or lateral shock on the coupling apparatus in one direction, and FIG. 12c illustrates door handle blocking on lateral shock applied to the coupling apparatus in the opposite direction;

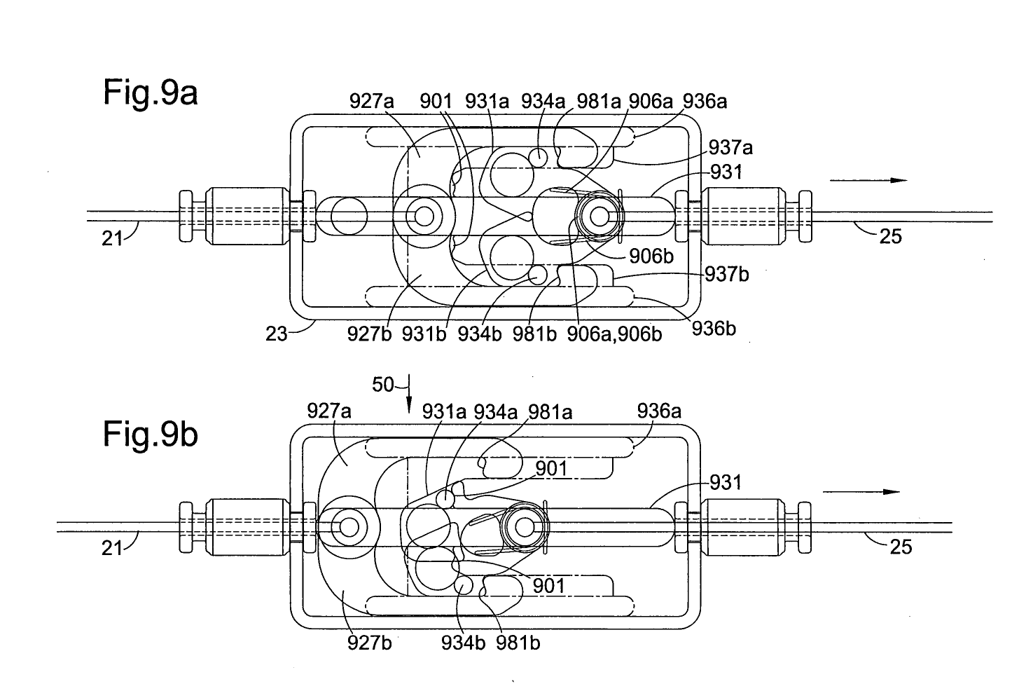

FIGS. 9a and 9b show apparatus according to a sixth embodiment of the invention, with dual inertia levers in tandem, in which FIG. 9a shows normal safe door handle operation and FIG. 9b shows door handle blocking on lateral shock applied to the coupling apparatus;

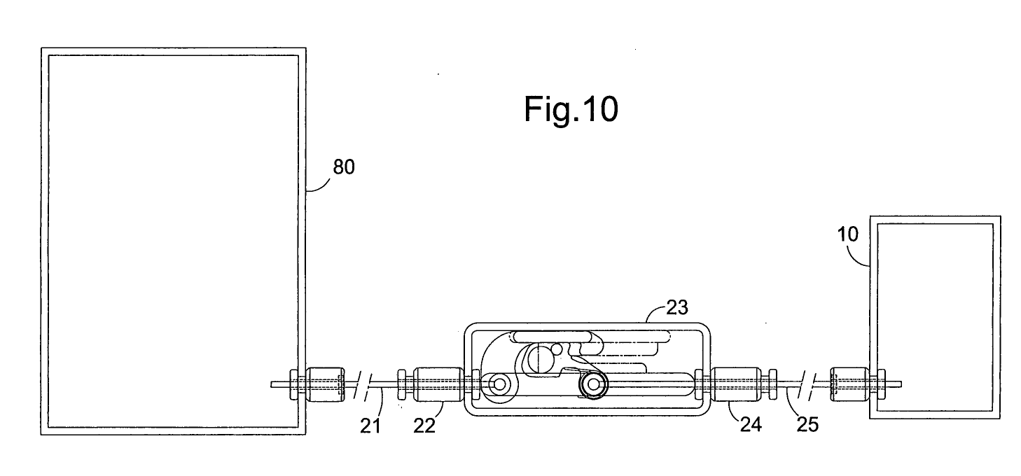

FIG. 10 is a schematic view of a system embodying the invention for use between a door handle and a latch;

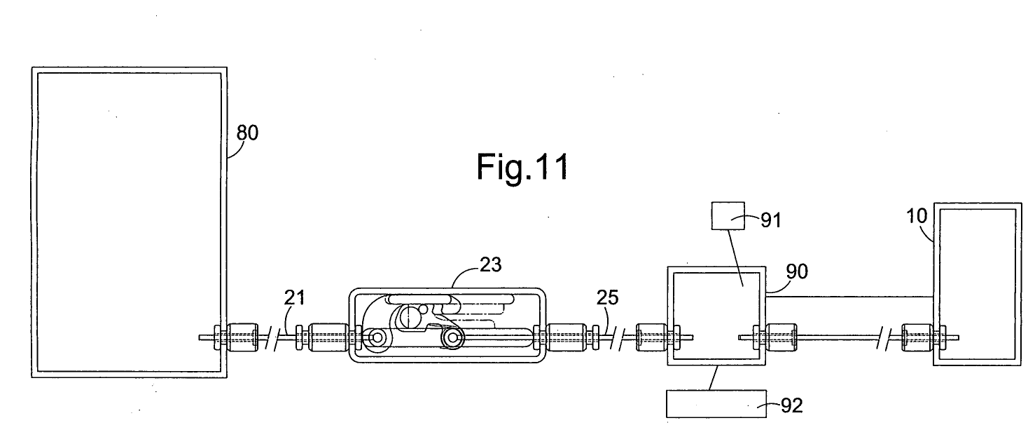

FIG. 11 is schematic view of a further system embodying the invention, for use with both an electrical actuator and a door handle; and

FIG. 12 is a schematic view of a further system embodying the invention, for use with an electrical actuator but without a manual door handle being connected.

As shown in FIG. 1, a conventional door handle 10 is mounted pivotally on a bar 11 running lengthwise of the vehicle on the vehicle door. Arms 101, 102 link the handle 10 to the bar 11. A massive counter weight 12 is also mounted pivotally on the bar 11. A coil spring 13 is mounted on the bar 11 to interconnect the counterweight and the handle rotationally so that excessive acceleration of the vehicle about the longitudinal axis of the vehicle does not have the effect of turning the handle 10.

As explained above, one of the advantages of the present invention is to avoid the need for such a counterweight, by ensuring that drive from the door handle 10 to a door latch is decoupled in the event that there is such an excessive acceleration of the vehicle. This might occur for example upon side impact of the vehicle, or rolling of the vehicle about its longitudinal axis, or spinning about a vertical axis.

A first embodiment of the coupling apparatus according to the invention is shown in FIGS. 2a to 2c. This apparatus is shown also in FIGS. 6 and 7, which are described in greater detail below.

In this embodiment, a drive cable 21 is connected to a latch in a vehicle door, and a further drive cable 25 is connected to the door handle 10, which could be similar to that of FIG. 1 but without the counter-weight. An elongate box shaped housing 23 is in the form of a shell, with a lid, shown more clearly in FIGS. 6 and 7. Terminal sleeves 22 and 24 are fixed to this housing 23 at respective ends, for guiding the ends of the cables 21 and 25. The cables may for example be Bowden cables with sheaths (not shown). Alternatively rods or strings or any other suitable couplings could be used.

A coupling catch 27, generally L-shaped, is mounted pivotally at one end to the end nipple 26 of the cable 21. A boss 261 projecting from the coupling catch 27 rides along an elongate groove 231 formed in the base of the housing 23, so that the pivotal point of the coupling catch slides axially along the housing. An elongate rectangular boss 28 projects from another limb of the coupling catch 27, and is guided along an elongate groove 29 in the lid 60 of the housing. In this way, the coupling catch 27 is constrained to move lengthwise with a sliding motion. The coupling catch 27 has an operative surface 281 for engagement with a corresponding operative surface 311 of an inertia lever 31.

The inertia lever 31 is in the shape of a comma, and is pivotally mounted at one end to the nipple 30 at the end of the cable 25 which connects to the door handle 10. A round boss 301 projecting from the inertia lever 31 slides along the elongate groove 231, to guide it longitudinally. Also, a circular boss 34 projecting upwardly from the inertia lever 31 is guided along an elongate track 341 in the housing lid 60. Together, these bosses 34, 301 constrain the inertia lever to longitudinal movement.

A metallic, massive cylinder 33 typically weighing about 3 g is held within the inertia lever 31, in a complementary recess, remote from its pivoted end, so that the overall centre of mass of the inertia lever 31 is remote from its pivot point. In one example, it is 15 mm from the pivot point. The cylinder 33 could of course be of any material, preferably substantially denser than the material from which the other components are made, apart from the spring 32 described below.

A torsion coil spring 32 disposed around the boss 301 biases the inertia lever 31 clockwise in FIG. 2a, such that its centre of mass is disposed transversely off the longitudinal axis through the pivot point 30. At the position shown in FIG. 2a, a flat surface of the inertia lever 31 abuts against a flat surface of the coupling catch 27, to prevent its continued clockwise rotational movement.

A longitudinal gap exists between the operative surfaces 311 and 281 of the inertia lever and the coupling catch respectively, in the rest position shown in FIG. 2a. This allows for inertial decoupling under fault conditions, as described below.

A finger 35 formed as a projection in the housing lid 60, and shown in FIGS. 2a and 7, guides the boss 34 of the inertia lever into one or other of two parallel channels 36 and 37, defined in the lid 60. Once the boss 34 has moved past the tip of the finger 35, it cannot change channels between channels 36 and 37: in this way, the apparatus stays either coupled or decoupled until the cable 25 is released.

Under normal operation, where the acceleration applied to cable 25 is below a predetermined threshold which may for example be 2 G, corresponding to a vehicle impact at about 5 km per hour, but could be in a range of 2 G to 3 G or 1.5 G to 4 G, tension on cable 25 pulls the inertia lever 31 towards the right, to move it from the position shown in FIG. 2a to that shown in FIG. 2b. The value of 2 G is equivalent to a spring force of 0.2N acting on the inertia lever at a radius of 15 mm from the pivot point. Once the gap has closed between the operative surfaces 311 and 281, the inertia lever is locked against the coupling catch and drags it lengthwise up the housing to the final position shown in FIG. 2b. This causes operation of the latch, since cable 21 is pulled. Release of the door handle 10 causes the apparatus to return to its rest position shown in FIG. 2a, due for example to a return spring in the latch pulling back the cable 21.

Under conditions of abnormal acceleration, above the predetermined threshold on cable 25, the inertia lever 31 swings counter clockwise, so that the centre of mass tends to move towards and usually past the longitudinal axis passing through its pivot point. As the inertia lever swings counter clockwise, so it is moved slidingly along the housing, closing the gap between operative services 311 and 281. If the acceleration on cable 25 is exactly at the predetermined threshold, the inertia lever 31 would have swung counter clockwise just sufficiently for surface 311 to clear surface 281 as it passes it, so that the components do not lock together. At accelerations above the threshold, the inertia lever will have swung even further than this. Accordingly, under fault conditions, the inertia lever continues its longitudinal sliding movement, to the position shown in FIG. 2c, at which the apparatus is decoupled. It will be seen that boss 34 slides along the lower channel 37 of the two possible channels 36, 37, under this fault condition. Once the tension on cable 25 is released, the coupling apparatus resets itself to the position shown in FIG. 2a.

A coupling apparatus very similar to that of FIGS. 2a to 2c is shown in perspective view in FIGS. 6 and 7, where like reference numerals are used for like components. The main difference is that in FIG. 6 the nipple 30 at the end of cable 25 is held in a bracket with a separate boss for mounting the torsion spring 32. Although this introduces complexity into the inertia lever 31, it can facilitate assembly of the components.

A second embodiment of the invention is shown in FIGS. 3a to 3d. This operates in a similar fashion to the first embodiment, except that there are two inertia levers 312, 313 which operate in opposite rotational directions. Correspondingly, there are two coupling catches 271, 272 facing each other; with operative engaging surfaces 282 and 283. In this example, a single torsion spring 321 is shared by both inertia levers, although of course each lever could have its own spring. Normal operation is shown in FIGS. 3b and 3c, with both inertia levers coupling to their respective coupling catches. Abnormal operation is shown in FIG. 3d, in which excessive acceleration causes both inertia levers to move closer to the central longitudinal axis, and to bypass the catches.

A third embodiment of the invention is shown in FIGS. 4a and 4b. In addition to the decoupling of the drive by virtue of the rotation of the inertia lever 43, which corresponds to lever 31 of FIGS. 2a to 2c, abnormal acceleration of cable 25 causes motion of the door handle (or other actuator) to be locked against the housing 23 and therefore the vehicle. Along one side of the housing there are notches 40, 41 and 42 forming a ratchet longitudinally of the housing. An engagement surface 44 on the inertia lever, opposite to the operative surface which engages the coupling catch, is shaped so as to lock against one or other of the notches of the ratchet. The engaging surfaces are shaped so as to retain the inertia lever 43 in its locked position against the ratchet, provided tension is maintained on cable 25. Depending on the degree of excessive acceleration above the predetermined threshold, the apparatus will lock the door handle (or other actuator) in one or other of the ratchet notches 40, 41 and 42. Engagement against the first notch 40 is shown in FIG. 4b.

It will be appreciated that a single notch, or any number of notches could replace the ratchet shown in FIGS. 4a and 4b.

The arrangement of this third embodiment shown in FIGS. 4a and 4b provides an extra fail-safe mechanism, against faulty operation of the door latch. Depending on the orientation at which the coupling apparatus is secured to the vehicle, it is conceivable that, in exceptional circumstances, an accelerating force acting transversely to the housing could cause the inertia lever to engage against the coupling catch despite accelerative tension on cable 25. The arrangement with the notch or ratchet should ensure that the inertia lever is unable to return to a position at which it locks against the coupling catch and re-engages the drive between cables 21 and 25.

A fourth embodiment of the invention is shown in FIGS. 5a and 5b. This is similar in operation to that of FIGS. 4a and 4b, except that in this example there are two inertia levers and two coupling catches, operating in tandem, as described with reference to FIGS. 3a to 3d. Also, there are correspondingly two ratchets, one on each side of the housing. In the event of a transverse acceleration 50 on the housing, causing the lower inertia lever 43 to swing downwardly as shown, despite tension on cable 25 in the direction of the arrow 51, inadvertent coupling is prevented by the engagement of inertia lever 43 against the lower ratchet, by virtue of the engagement of its operative surface 44 with notch 40.

In any of the embodiments, the coil spring 32, 321 could be replaced with some alternative means for ensuring the inertia lever is aligned correctly to couple with the coupling lever. With the single lever example of FIG. 2, it may be sufficient to rely on the weight of the lever itself, provided the coupling apparatus is mounted at the correct orientation to the vehicle i.e. the reverse of that shown in FIG. 2.

A fifth embodiment of the coupling apparatus according to the invention is shown in FIGS. 8a to 8c. This functions in a similar way to the third embodiment, shown in FIGS. 4a and 4b, in that the operation of the door handle is blocked in the event of an excessive side impact on the frame 23 in one direction.

As shown in FIG. 8a, a coupling catch 827 has its pivot point slidable axially along a groove 231. An elongate arm of the coupling catch 827 has upwardly projecting bosses 807 and 804 which are guided to slide axially along an elongate groove 836 formed in the lid 60. A further boss 802, adjacent boss 804, is arranged to slide along a parallel and adjacent guiding slot 837 formed in the lid 60. The face of the coupling catch 827 which faces the lid 60 is formed with a recess between the bosses 807 and 804, for accommodating the inertia lever 831.

Transversely extending abutment surfaces 801 and 802 are formed in the lid 60, in order to block the movement of the door handle cable 25 in the event of excessive lateral impact or acceleration on the frame 23, as described below. A transversely extending, but angularly inclined, abutment surface 808 on the coupling catch 827 is formed as a shoulder, defining the forward wall of the recess mentioned above, and this serves as an abutment surface for locking the inertia lever 831 against the coupling catch 827 under normal operation for door release.

A dual return spring 806 is mounted over the pivot bracket for the inertia lever 831, in place of the coil spring 32 of FIG. 2. This resiliently biases the inertia lever 831 to the middle position as shown in FIG. 8a. It causes the lever 831 to return to that middle position if it has swung to either of the rotational positions shown in FIGS. 8a and 8c.

Normal operation of the coupling apparatus of FIG. 8a will now be described. Provided the acceleration applied by the door handle to its cable 25 is less than the predetermined threshold, for example 2 G, the inertia lever 831 will not have swung counter clockwise sufficiently for it to bypass the abutment surface 808 on the coupling catch 827. Thus the tendency for the massive cylinder 33 to move towards the longitudinal axis through the pivot point of the inertia lever is sufficiently countered by the clockwise spring force of the spring 806. Once the gap between the respective engagement surfaces of the inertia lever and the coupling catch has closed, upon translation of the cable 25, the two elements lock together and allow the latch to operate to open the door, as described with reference to other embodiments of the invention. At the same time, bosses 834a and 834b projecting from the surface of the inertia lever which faces the lid 60 slide axially along the slot 837.

If the acceleration applied to the cable 25 exceeds the threshold, then, as shown in FIG. 8b, the inertia lever 831 swings counter clockwise so that it bypasses the abutment surface 808 on the coupling catch by the time the gap between its engagement surfaces has closed. The inertia lever is then free to slide axially until the forward boss 834b abuts against the abutment surface 802 in the lid 60. This engagement of the boss 834b is shown in FIG. 8b. The arcuate shape of the abutment surface 802 locks the boss 834b against counter clockwise movement until such time as tension on the cable 25 is released. At that point, the dual return spring 806 moves the inertia lever back to its middle position. The effect of this is to block movement of the door handle cable 25.

Under very exceptional circumstances, the acceleration applied to the cable 25 may be below the predetermined threshold, even though the vehicle is impacted, for example in a direction 50 transverse to the frame 23. In this situation, unsafe operation of the door release mechanism is prevented by blocking the door handle cable 25, as shown in FIGS. 8b and 8c for different directions of the acceleration or impact transversely of the frame 23. It will be understood from the description above of FIG. 8b that acceleration of the frame 23 on the axis 50 would have the effect of swinging the inertia lever 831 either clockwise or anticlockwise. Counter clockwise swinging would cause it to block as shown in FIG. 8b. Clockwise swinging motion would cause it to move to the position shown in FIG. 8c, at which the rear boss 834a on the inertia lever slides into abutment against the abutment surface 831 on the lid 60. Again, once the acceleration or impact has stopped, and tension on the cable 25 has been released, the dual return spring 806 will return the inertia lever to its middle position.

A sixth embodiment of the invention is shown in FIGS. 9a and 9b, and this is similar in operation to that of the fifth embodiment shown in FIGS. 8a to 8c, except that there are dual inertia levers 931a and 931b operating in tandem. There is also a pair of coupling catches 927a and 927b, pivoted on a common mounting point which slides along an axial slot 931 formed in the base of the housing. A pair of coil springs 906a, 906b operate independently on the same mounting point, to resiliently bias the respective inertia levers into locking engagement against their respective coupling catches, in a similar way to the second embodiment shown in FIG. 3.

Each coupling catch has an elongate projection (not shown) which guides it to slide along the elongate slot 936a, 936b formed in the lid 60. A boss 934a, 934b formed on each inertia lever guides the lever to slide axially along a groove 937a, 937b respectively in the lid 60. As shown in FIG. 9a, rearwards facing abutment or engagement surfaces 981a and 981b are formed respectively on the coupling catches 927a, 927b for locking engagement with corresponding engagement surfaces on the inertia levers.

Normal operation of the coupling apparatus is shown in FIG. 9a, in which acceleration on the cable 25 below the threshold allows the axial gap between the inertia levers and the coupling catches to close whilst the springs ensure that the inertia levers lock against their respective coupling catches.

Excessive acceleration applied to the door handle cable 25 causes the inertia levers to swing towards the centre of the frame, to cause the respective bosses 934a, 934b to lock against respective abutment surfaces 901 formed in the lid 60. This blocks further movement of the door handle cable 25.

In the event of excessive lateral impact or acceleration 50 as shown in FIG. 9b, applied to the frame 23, a corresponding one of the inertia levers will swing to an extreme position at which it engages against one of the abutment surfaces 901. Depending on the direction of the acceleration along the axis 50, this will be one or other of the inertia levers. Thus safe operation in the event of such a side impact is ensured, regardless of its direction. Once again, the springs reset the coupling apparatus once accelerations have stopped.

The arrangements shown in FIGS. 1 to 9 can be used in a number of different systems for controlling latches for doors or tailgates or other closure mechanisms, as shown in FIGS. 10 to 12.

In the system shown in FIG. 10, a conventional door handle 10 controls a conventional latch 80 through Bowden cables 21, 25 in which the apparatus embodying the invention is disposed in line, i.e. in series.

In the arrangement shown in FIG. 11, an electrical actuator 90 is also disposed in line, between the handle 10 and the cable 25. This provides for electrical control of the door latch 80, in addition to manual control through the handle. The electrical control 90 is controlled by control electronics unit 92 and by a switch 91 mounted on or adjacent to the exterior door handle 10 or the interior.

In the arrangement shown in FIG. 12, there is no manual door handle for the exterior, and instead entry is controlled by an electrical switch 91, for example using keyless entry systems or a microswitch. A door release electrical actuator and its control electronics are shown as box 1000, containing a mechanical gearing and indexing system 1001, a motor 1002, a microprocessor 1003 and a control electronics unit 1004.

With electric actuators, there is a possibility of a fault condition developing, or of interference for example by criminal activity, which might cause incorrect actuation, i.e. at an acceleration over the predetermined threshold such as 2 G. This could happen if an electric motor power supply is not correctly modulated by control circuitry, so that the motor within the actuator is driven at maximum power to apply excessive force.

The component parts of the coupling apparatus are preferably made of plastics wherever possible—i.e. probably excluding the spring and the massive cylinder. Conveniently they may be plastics mouldings.

The invention has been illustrated in its application to the control of a door latch, but it is also applicable to a wide range of other mechanically actuable mechanisms where safety in the event of an impact is important.

The preferred embodiments are linear actuators, with the inertia lever and catch both following a linear path in the housing. However, this could be modified to a rotary arrangement in which both inertia lever and catch follow arcuate paths. In this case when the inertia lever is at a position at which it locks against the catch to couple drive from the actuator to the cable, its centre of mass is shifted transversely from a line through its pivotal mounting on the bracket parallel at that point to the path of the inertia lever.

1. Apparatus for coupling operational drive mechanically by way of a cable from an actuator to a mechanism such as a door latch, comprising:
a frame for mounting in a fixed position relative to the door latch and the actuator;
an inertia lever pivotally mounted on a bracket constrained to slide along a predetermined path within the frame, the inertia lever having a centre of mass distant from its pivotal mounting on the bracket;
a catch constrained to slide along a predetermined path within the frame, following the path of the inertia lever;
means for connecting the bracket to the actuator;
and means for connecting the catch to the said mechanism such as a door latch;
the apparatus being configured such that when the inertia lever is at a position at which it locks against the catch to couple drive from the actuator to the cable, its centre of mass is shifted transversely from a line through its pivotal mounting on the bracket parallel at that point to the path of the inertia lever;
such that when no driving force is applied from the actuator there is an axial gap between mutually-engaging surfaces of the catch and the inertia lever, but when the actuator applies normal driving force, the inertia lever slides to close that gap and then to lock against the catch;
and such that axial acceleration of the inertia lever above a predetermined threshold, corresponding to an unsafe fault condition, causes the off-axis inertia lever to swing to move its centre of mass closer to axial alignment with its pivotal mounting point, sufficiently to bypass the catch by the time the gap has closed, whereby to decouple the operational drive.

2. Apparatus according to claim 1, in which the predetermined paths are straight and parallel to each other along an axis, so as to couple axial drive from the actuator to the cable.

3. Apparatus according to claim 1, comprising a blocking projection on the frame positioned to abut against the inertia lever when it has swung such that it would bypass the catch under the said fault condition or under lateral impact or acceleration applied to the frame, to block continued axial movement of the inertia lever.

4. Apparatus according to claim 1, comprising a further inertia lever and a further catch operable in tandem with the said inertia lever and catch but with the further inertia lever swinging in an opposite direction transversely of the frame axis.

5. Apparatus according to claim 4, comprising, for each of the inertia levers, a blocking projection on the frame positioned to abut against the inertia lever when it has swung such that it would bypass the catch under the said fault condition or under lateral impact or acceleration applied to the frame, to block continued axial movement of the inertia lever.

6. Apparatus according to claim 4, in which the two inertia levers share a common slidable bracket.

7. Apparatus according to claim 3, in which the blocking projection is one of a series of such projections arranged axially to form a ratchet.

8. Apparatus according to claim 1, in which the frame comprises an enclosed housing.

9. Apparatus according to claim 1, in which the connecting means for the actuator is arranged to connect to a further cable.

10. Apparatus according to claim 1, in which the inertia lever, coupling catch and frame are of plastics material.

11. Apparatus according to claim 10, in which the inertia lever holds a massive body of a material denser than the plastics material.

12. Apparatus according to claim 1, comprising means for resiliently biasing the inertia lever to the rotational position at which it can lock against the catch.

13. Apparatus according to claim 4, comprising means for resiliently biasing the inertia lever to the rotational position at which it can lock against the catch and in which the two inertia levers share a common biasing means.

14. Apparatus according to claim 12, in which the biasing means or each biasing means is a coil spring.

15. Apparatus according to claim 5, comprising means for resiliently biasing the inertia lever to the rotational position at which it can lock against the catch and in which the biasing means comprise a coil spring for each inertia lever.

16. Apparatus according to claim 3, comprising means for resiliently biasing the inertia lever to the rotational position at which it can lock against the catch and in which the biasing means comprises a dual return spring, and comprising two such blocking projections arranged to abut the inertia lever respectively when the lever has swung clockwise or counter-clockwise from a central position at which it may engage with the coupling catch.

17. A door latch control system comprising a latch, a door handle constituting the actuator, and coupling apparatus according to claim 1 operatively connected by cables therebetween, to provide inertial safety decoupling.

18. A door latch control system according to claim 17, further comprising an electrical actuator operatively connected in line by cables between the door handle and the coupling apparatus, whereby the latch is operable selectively by the door handle or by the electrical actuator, and the coupling apparatus provides inertial safety decoupling.

19. A door latch control system comprising a latch and an electrical actuator operatively coupled drivingly to coupling apparatus according to claim 1 therebetween.

20. A door latch control system according to claim 19, comprising an electrical switch adjacent a door handle for controlling the electrical actuator.

21. A method of decoupling drive from an actuator to a mechanism such as a door latch in the event of abnormal acceleration such as upon impact, using mechanical coupling apparatus therebetween, in which the coupling apparatus couples the drive when operated normally but decouples the drive whenever the acceleration of the drive applied by the actuator exceeds a pre-determined threshold.

22. A method according to claim 21, in which the coupling apparatus also blocks movement of the actuator when it decouples the drive.

23. A method according to claim 21, in which the coupling apparatus resets itself once normal conditions are resumed.

24. A method according to claim 21, in which the mechanism is a vehicle door latch.
